(19) United States
(12) Patent Application Publication
(10) Pub. No.: US 2003/0125947 A1
(43) Pub. Date: Jul. 3, 2003

(54) Network-accessible speaker-dependent voice models of multiple persons

(76) Inventor: Michael Allen Yudkowsky, Chicago, IL (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/038,409

(22) Filed: Jan. 3, 2002

(51) Int. Cl. G10L 17/00; G10L 15/00

(52) U.S. Cl. 704/247

(57) ABSTRACT

A voice model database server determines the identity of a speaker through a network over which the voice model database server provides to one or more speech-recognition systems output data regarding a person with access to the speech-recognition system receiving the output data. The voice model database server attempts to locate, based on the identity of the speaker, a voice model for the speaker. Finally, the voice model database server retrieves from a storage area the voice model for the speaker, if the voice model database server located a voice model for the speaker.

### FIELD OF THE INVENTION

The present invention relates to automatic speech recognition (ASR). More particularly, the invention relates to network-accessible speaker-dependent voice models of multiple persons for ASR purposes.

### BACKGROUND OF THE INVENTION

Automatic speech recognition (ASR) is a type of voice technology that allows people to interact with computers using spoken words. ASR is used in connection with telephone communication to enable a computer to interpret a caller's spoken words and respond in some way to the speaker. Specifically, a person calls a telephone number and is connected to an ASR system associated with the called telephone number. The ASR system uses audio prompts to prompt the caller to provide an utterance, and analyzes the utterance using voice models. In many ASR systems, the voice models are “speaker-independent.”

A speaker-independent voice model contains models of phonemes generated from vocalizations of numerous words by multiple speakers whose speech patterns collectively represent the speech patterns of the general population. By contrast, a speaker-dependent voice model contains models of phonemes generated from vocalizations of numerous words by one individual, and thus represents the speech patterns of that individual.

Using the phonemes from the speaker-independent voice model, ASR systems compute a hypothesis as to the phonemes contained in the utterance, as well as a hypothesis as to the words the phonemes represent. If confidence in the hypothesis is sufficiently high, the ASR system uses the hypothesis as an indicator of the content of the utterance. If confidence in the hypothesis is not sufficiently high, the ASR system typically enters error-recovery routines, such as prompting the caller to repeat the utterance. FIG. 1 illustrates transmission of an utterance from a caller to an ASR system that uses a speaker-independent voice model to perform ASR.

Using speaker-independent voice models that reflect the speech patterns of the general population reduces the accuracy of ASR systems used in connection with telephone communication. Specifically, speaker-independent voice models, unlike speaker-dependent voice models, are not generated using the speech patterns of each individual caller. Consequently, ASR systems can have difficulty with a caller whose speech varies from the norms of the speaker-independent voice models sufficiently to inhibit the ASR system's ability to recognize the caller's utterance.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram illustrating the transmission of an utterance from a caller to an ASR system.

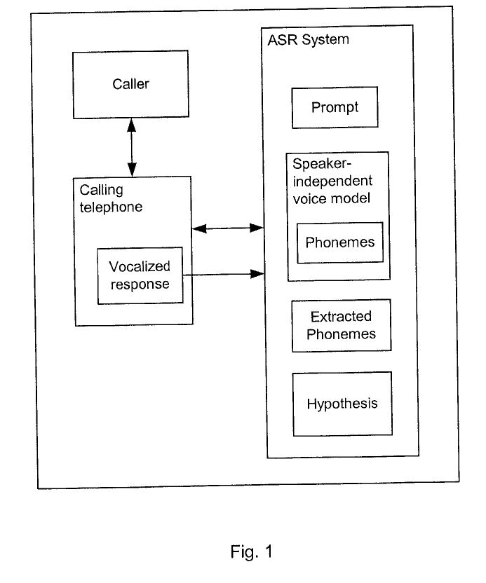

FIG. 2 is a flow chart of a method of one embodiment of providing network-accessible speaker-dependent voice models of multiple persons.

FIG. 3 is a block diagram of a system that contains network-accessible speaker-dependent voice models for multiple persons.

FIG. 4 is a block diagram of an electronic system.

### DETAILED DESCRIPTION

A method of providing network-accessible speaker-dependent voice models of multiple persons is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

A method of providing network-accessible speaker-dependent voice models of multiple persons for automatic speech recognition (ASR) purposes is described. A caller dials a telephone number. The caller uses a calling device that is part of a network over which any ASR system can receive, from a voice model database server, data regarding a speaker who can access the ASR system receiving the data. The voice model database server is a device that can access speaker-dependent voice models for multiple persons.

At some point (e.g., while waiting to be connected to the called telephone or after being connected to the called telephone), the caller is identified by the voice model database server, or by another device in the network. The voice model database server attempts to locate a speaker-dependent voice model for the identified caller. If the voice model database server locates a speaker-dependent voice model for the caller within the voice model database server or in a location external to the voice model database server, the voice model database server retrieves the speaker-dependent voice model. If no speaker-dependent voice model exists for the caller, a speaker-independent voice model is used to perform ASR, and ASR results can be used to generate a speaker-dependent voice model for the caller.

The caller's telephone is connected to the voice model database server. The voice model database server uses an audio prompt to prompt the caller to provide an utterance. The caller provides the utterance, and the voice model database server uses the speaker-dependent voice model retrieved for the caller to extract phonemes from the utterance. The voice model database server then transmits the phonemes to an ASR system associated with the called telephone number, which uses the phonemes to compute a hypothesis as to the content of the utterance.

Alternatively, rather than extracting phonemes from an utterance, the voice model database server transmits a caller's speaker-dependent voice model to an ASR system that has been connected over the network to the caller's telephone. The ASR system then prompts the caller to provide an utterance. After receiving the utterance, the ASR system uses the caller's speaker-dependent voice model to extract phonemes from the utterance.

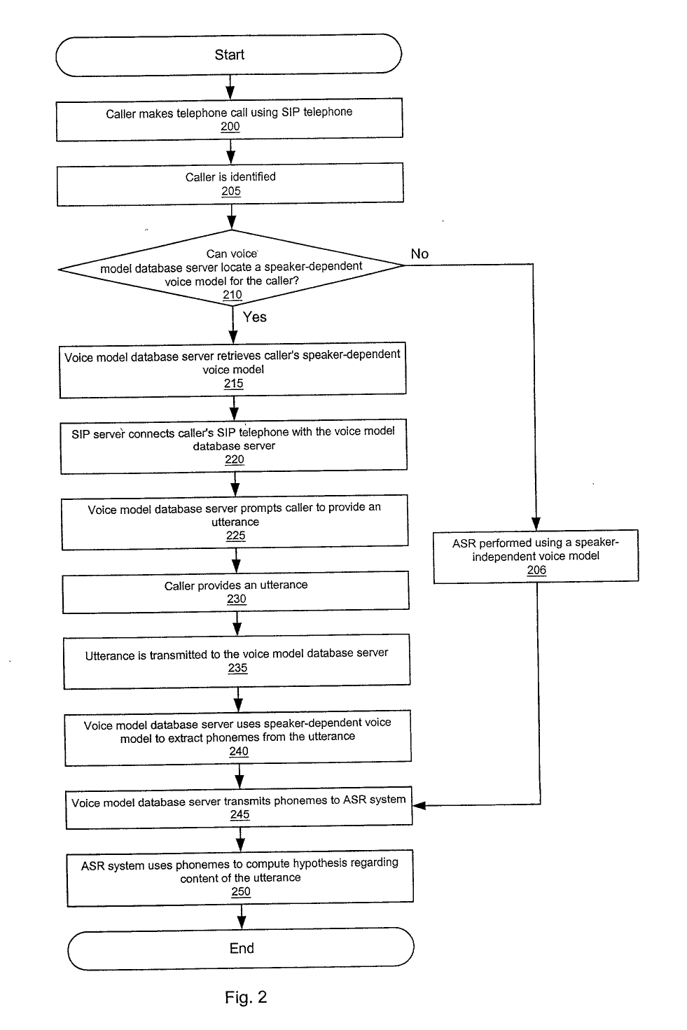

FIG. 2 is a flow chart of a method of one embodiment of providing an ASR system with network-accessible speaker-dependent voice models for multiple persons.

Session Initiation Protocol (SIP) is a protocol that allows people to call each other using SIP-enabled devices (e.g., SIP telephones or personal computers) that are connected using the Internet Protocol (IP) addresses of the SIP-enabled devices. When a person uses a SIP-enabled telephone to make a telephone call in a network that uses SIP, a SIP server (i.e., a server that runs applications for establishing connections between devices and uses SIP to communicate with the devices) receives from the SIP client of the calling SIP telephone (a SIP client is an application program of a calling or a called SIP device, depending on the context) the telephone numbers of the calling SIP telephone and the called SIP telephone. The SIP server then determines the IP addresses of the two SIP telephones, and establishes a connection between the two SIP telephones.

SIP servers typically establish connections between SIP telephones in a next generation network (NGN). An NGN (e.g., the Internet) is an interconnected network of electronic systems, e.g., personal computers, over which voice is transmitted as packets of data between the calling telephone and the called telephone, without the signaling and switching systems used in a PSTN. A PSTN is a collection of interconnected public telephone networks that uses a signaling system (e.g., the multi-frequency tones used with push-button telephones) to send a call to a called telephone, and a switching system to connect the called telephone with a calling telephone. Using additional protocols and/or a bridge between the NGN and PSTN, SIP servers can establish connections between SIP telephones in a combined NGN/PSTN network.

For purposes of illustration and ease of explanation, FIG. 2 will be described in specific terms of providing a speaker-dependent voice model for a caller making a telephone call using a SIP telephone operating in a network, e.g., an NGN or a PSTN. However, a caller is not limited to using a SIP telephone in order to have a speaker-dependent voice model provided for the caller. In addition, a server that runs applications directed at establishing connections between devices can use a protocol other than SIP, e.g., H.323, to communicate with the devices. See, e.g., International Telecommunications Union—Telecommunication Standardization Sector (ITU-T) Recommendation H.323: Packet-based Multimedia Communications Systems, Draft H.323v4 (Including Editorial Corrections—February 2001). Finally, FIG. 2 will be described in specific terms of providing a speaker-dependent voice model for a speaker who is using a telephone. However, a speaker-dependent voice model can be provided for a speaker interfacing with an ASR system other than via a telephone. For example, a speaker-dependent voice model can be provided for a person who walks up to an automated teller machine and uses voice commands to operate the machine.

At 200, a caller makes a telephone call using a SIP telephone that is part of a network (e.g., an NGN) over which any ASR system can receive from a voice model database server data regarding a speaker with access to the ASR system receiving the data. At 205, the caller is identified. In one embodiment, a SIP server identifies the caller. In an alternative embodiment, a voice model database server containing speaker-dependent voice models for multiple persons identifies the caller. In one embodiment, the caller is identified while the caller is waiting for an answer at the called telephone number. However, the caller can be identified at other times, e.g., after there is an answer at the called telephone number. In one embodiment, the caller is identified based on the caller's telephone number. However, identification of the caller is not limited to using the caller's telephone number to perform the identification, e.g., the caller could provide some identifying information such as a social security number which is used to identify the caller.

At 210, the voice model database server determines, based on the identity of the speaker, whether it can locate a speaker-dependent voice model for the caller. In one embodiment, the SIP server, having identified the caller, provides the identity of the caller to the voice model database server, and requests that the voice model database server locate a speaker-dependent voice model for the caller. The voice model database server, if it locates a speaker-dependent voice model for the caller, communicates to the SIP server that a speaker-dependent voice model for the caller has been located. In an alternative embodiment, the voice model database server, having identified the caller, determines whether it can locate a speaker-dependent voice model for the caller.

A voice model is a set of data, e.g., models of phonemes or models of words, used to process an utterance so that a speech recognition system can determine the content of the utterance. Phonemes are the smallest units of sound that can change the meaning of a word. A phoneme may have several allophones, which are distinct sounds that do not change the meaning of a word when interchanged. For example, l at the beginning of a word (as in lit) and l after a vowel (as in gold) are pronounced differently, but are allophones of the phoneme l. The l is a phoneme because replacing it in the word lit would cause the meaning of the word to change. Voice models and phonemes are well-known to those of ordinary skill in the art, and thus will not be discussed further except as they pertain to the present invention.

At 215, if the voice model database server locates a speaker-dependent voice-model for the caller, then the voice model database server retrieves the speaker-dependent voice model. In one embodiment, the caller's speaker-dependent voice model is stored within the voice model database server. In an alternative embodiment, the voice model database server retrieves the caller's speaker-dependent voice model from another network-accessible location, e.g., the caller's personal computer.

If the voice model database server cannot locate a speaker-dependent voice model for the caller, then at 216 an ASR system at the called telephone number performs ASR using a speaker-independent voice model. In an alternative embodiment, once the ASR system has used the speaker-independent voice model to recognize the content of the caller's utterance, the ASR system returns the contents of the recognized utterance to the voice model database server. The voice model database server then uses the contents of the recognized utterance to generate a speaker-dependent voice model for the caller.

At 220, the SIP server connects the caller's telephone over the network to the voice model database server. At 225, the voice model database server prompts the caller to provide an utterance in response to an audio prompt. The utterance may contain vocalized words, or vocalized sounds, e.g., grunts, that are not considered words. In one embodiment, the voice model database server receives the audio prompt from a SIP client of the called device. At 230, the caller provides an utterance, which at 235 is transmitted to the voice model database server. At 240, the voice model database server uses the speaker-dependent voice model it retrieved for the caller to extract phonemes from the caller's utterance. The process of extracting phonemes from an utterance is well-known to those of ordinary skill in the art, and thus will not be discussed further except as it pertains to the present invention.

In an alternative embodiment, “Aurora features” are extracted from an utterance in a Distributed Speech Recognition (DSR) system, and the Aurora features are transmitted to the voice model database server. The voice model database server then uses the caller's speaker-dependent voice model to extract phonemes from the Aurora features. Distributed Speech Recognition (DSR) enhances the performance of mobile voice networks connecting wireless mobile devices (e.g., cellular telephones) to ASR systems. With DSR, an utterance is transmitted to a “terminal,” which extracts “Aurora features,” from the utterance. The Aurora DSR Working Group within the European Technical Standards Institute (ETSI) has been developing a standard to ensure compatibility between a terminal and an ASR system. See, e.g., ETSI ES 201 108 V1.1.2 (2000-04) Speech Processing, Transmission and Quality aspects (STQ); Distributed speech recognition; Front-end feature extraction algorithm; Compression algorithms (published April 2000).

At 245, the voice model database server transmits the phonemes over the network to an ASR system associated with the called telephone number. At 250, the ASR system uses the phonemes received from the voice model database server to compute a hypothesis as to the content of the utterance. In one embodiment, once the content of the utterance is correctly recognized, the recognized response is transmitted to the voice model database server, which uses the recognized response to update the caller's speaker-dependent voice model.

In an alternative embodiment, the SIP server connects the caller's telephone over the network directly to the ASR system, rather than to the voice model database server. The ASR system receives from the voice model database server a speaker-dependent voice model for the identified caller, and prompts the caller to provide an utterance. The ASR system then uses the caller's speaker-dependent voice model to extract phonemes from the utterance.

FIG. 2 describes the technique for providing to network-accessible speaker-dependent voice models for multiple persons in terms of a method. However, one should also understand it to represent a machine-accessible medium having recorded, encoded or otherwise represented thereon instructions, routines, operations, control codes, or the like, that when executed by or otherwise utilized by the machine, cause the machine to perform the method as described above or other embodiments thereof that are within the scope of this disclosure.

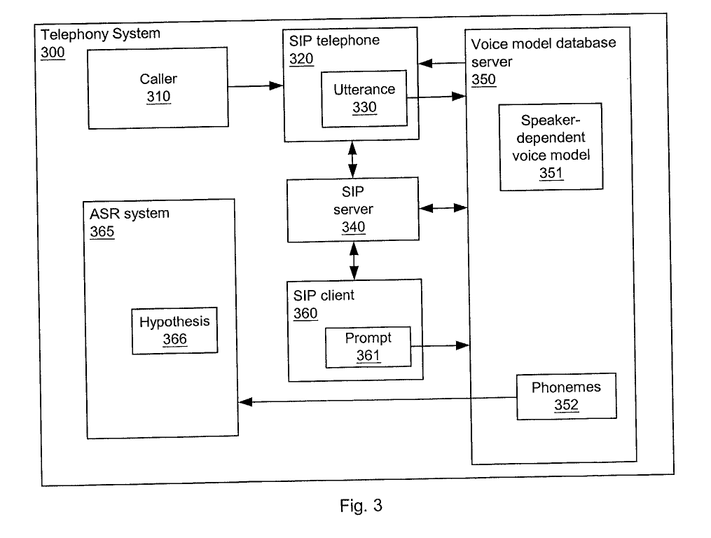

FIG. 3 is a block diagram of telephony system 300 (e.g., an NGN) containing a voice model database server that stores speaker-dependent voice models for multiple persons for ASR purposes. For purposes of illustration and ease of explanation, FIG. 3 will be described in specific terms of providing a speaker-dependent voice model for a caller making a telephone call using a SIP telephone. However, a caller is not limited to using a SIP telephone in order to have a speaker-dependent voice model provided for the caller.

Caller 310 uses SIP telephone 320 to call a telephone number that uses ASR system 365 to answer calls. SIP server 340 determines the identity of caller 310, and asks voice model database server 350 whether it can locate a speaker-dependent voice model for caller 310. Voice model database server 350 communicates to SIP server 340 that it has located speaker-dependent voice model 351 for caller 310, and retrieves speaker-dependent voice model 351.

SIP server 340 connects SIP telephone 320 over a network to voice model database server 350, which uses prompt 361 received from SIP client 360 to prompt caller 310 to provide utterance 330. Utterance 330 is transmitted to voice model database server 350. Voice model database server 350 uses speaker-dependent voice model 351 to extract phonemes 352 from utterance 330. Voice model database server 350 transmits phonemes 352 over the network to ASR system 365, which uses phonemes 352 to compute hypotheses 366 regarding the content of utterance 330.

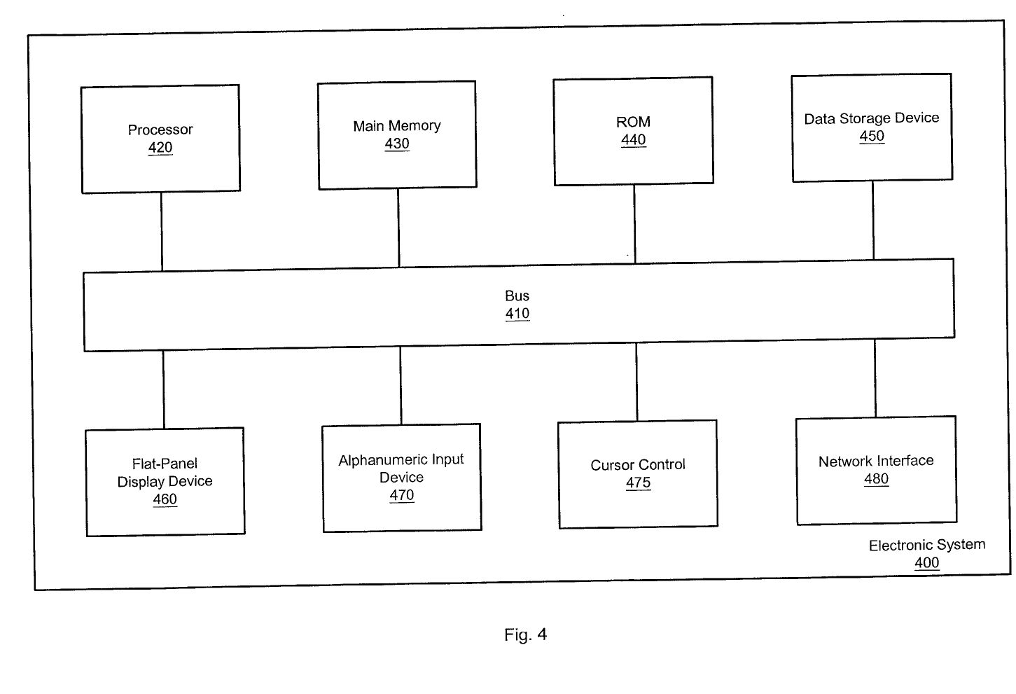

In one embodiment, the technique of FIG. 2 can be implemented as sequences of instructions executed by an electronic system, e.g., a voice model database server, a SIP server, or an ASR system, coupled to a network. The sequences of instructions can be stored by the electronic system, or the instructions can be received by the electronic system (e.g., via a network connection). FIG. 4 is a block diagram of one embodiment of an electronic system coupled to a network. The electronic system is intended to represent a range of electronic systems, e.g., computer systems, network access devices, etc. Other electronic systems can include more, fewer and/or different components.

Electronic system 400 includes a bus 410 or other communication device to communicate information, and processor 420 coupled to bus 410 to process information. While electronic system 400 is illustrated with a single processor, electronic system 400 can include multiple processors and/or co-processors.

Electronic system 400 further includes random access memory (RAM) or other dynamic storage device 430 (referred to as memory), coupled to bus 410 to store information and instructions to be executed by processor 420. Memory 430 also can be used to store temporary variables or other intermediate information while processor 420 is executing instructions. Electronic system 400 also includes read-only memory (ROM) and/or other static storage device 440 coupled to bus 410 to store static information and instructions for processor 420. In addition, data storage device 450 is coupled to bus 410 to store information and instructions. Data storage device 450 may comprise a magnetic disk (e.g., a hard disk) or optical disc (e.g., a CD-ROM) and corresponding drive.

Electronic system 400 may further comprise a flat-panel display device 460, such as a cathode ray tube (CRT) or liquid crystal display (LCD), to display information to a user. Alphanumeric input device 470, including alphanumeric and other keys, is typically coupled to bus 410 to communicate information and command selections to processor 420. Another type of user input device is cursor control 475, such as a mouse, a trackball, or cursor direction keys to communicate direction information and command selections to processor 420 and to control cursor movement on flat-panel display device 460. Electronic system 400 further includes network interface 480 to provide access to a network, such as a local area network.

Instructions are provided to memory from a machine-accessible medium, or an external storage device accessible via a remote connection (e.g., over a network via network interface 480) providing access to one or more electronically-accessible media, etc. A machine-accessible medium includes any mechanism that provides (i.e., stores and/or transmits) information in a form readable by a machine (e.g., a computer). For example, a machine-accessible medium includes RAM; ROM; magnetic or optical storage medium; flash memory devices; electrical, optical, acoustical or other form of propagated signals (e.g., carrier waves, infrared signals, digital signals); etc.

In alternative embodiments, hard-wired circuitry can be used in place of or in combination with software instructions to implement the present invention. Thus, the present invention is not limited to any specific combination of hardware circuitry and software instructions.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

[image]

What is claimed is:

1. A method, comprising:
determining an identity of a speaker through a network over which output data, regarding a person with access to a speech-recognition system receiving the output data, is provided to one or more speech-recognition systems;
attempting to locate, based on the identity of the speaker, a voice model for the speaker; and
retrieving from a storage area the voice model for the speaker if the voice model for the speaker is located.

2. The method of claim 1, wherein the voice model comprises a speaker-dependent voice model.

3. The method of claim 2, wherein determining the identity of the speaker over the network comprises using information received from the speaker over the network to determine the identity the speaker.

4. The method of claim 2, wherein determining the identity of the speaker over the network comprises:
receiving from a device in the network identifying data regarding the speaker; and
determining the identity of the speaker based on the identifying data regarding the speaker.

5. The method of claim 2, wherein the storage area comprises an internal storage area containing speaker-dependent voice models for multiple persons.

6. The method of claim 2, wherein the storage area comprises an external storage area accessible over the network.

7. The method of claim 2, wherein the output data comprise phonemes.

8. The method of claim 7, further comprising:
receiving an utterance from the speaker;
using the voice model to extract phonemes from the utterance; and
transmitting the phonemes over the network to the speech-recognition system.

9. The method of claim 8, wherein the utterance comprises one or both of vocalized words and vocalized sounds.

10. The method of claim 9, further comprising:
receiving from the speech-recognition system contents of a recognized utterance of the speaker; and
revising the voice model for the speaker based on the contents of the recognized utterance.

11. The method of claim 2, wherein the output data comprise a voice model for the speaker.

12. The method of claim 11, further comprising transmitting the voice model over the network to the speech-recognition system.

13. The method of claim 2, further comprising
receiving Aurora features extracted from an utterance of the speaker;
extracting phonemes from the Aurora features; and
transmitting the phonemes over the network to a speech recognition system.

14. The method of claim 2, further comprising:
retrieving a speaker-independent voice model if failing to locate the voice model for the speaker;
receiving an utterance from the speaker;
using the speaker-independent voice model to extract phonemes from the utterance;
transmitting the phonemes over the network to a speech-recognition system;
receiving from the speech-recognition system contents of a recognized utterance of the speaker; and
generating a voice model for the speaker based on the contents of the recognized utterance.

15. A method, comprising:
accessing by a speaker a network containing a speech recognition system;
identifying by a first device the speaker based on information provided by the speaker;
requesting by the first device a speaker-dependent voice model for the speaker from a voice model database server providing phonemes to any speech recognition system in the network;
retrieving by the voice model database server the speaker-dependent voice model from a storage area if the voice model database server locates a speaker-dependent voice model for the speaker;
connecting by the first device the speaking device with the voice model database server;
prompting by the voice model database server the speaker to provide an utterance;
speaking by the speaker the utterance into the speaking device;
receiving by the voice model database server the utterance;
using by the voice model database server the speaker-dependent voice model to extract phonemes from the utterance;
transmitting by the voice model database server the phonemes over the network to a speech-recognition system; and
using by the speech-recognition system the phonemes to determine a content of the utterance.

16. The method of claim 15, wherein the storage area comprises a storage area within the voice model database server containing speaker-dependent voice models for multiple persons.

17. The method of claim 15, wherein the storage area comprises a storage area accessible by the voice model database server over the network.

18. An article of manufacture comprising:
a machine-accessible medium including thereon sequences of instructions that, when executed, cause one or more machines to:
determine an identity of a speaker through a network over which output data, regarding a person with access to a speech-recognition system receiving the output data, is provided to one or more speech-recognition systems;
attempt to locate, based on the identity of the speaker, a voice model for the speaker; and
retrieve from a storage area the voice model for the speaker if the voice model for the speaker is located.

19. The article of manufacture of claim 18, wherein the sequences of instructions that, when executed, cause the one or more machines to attempt to locate, based on the identity of the speaker, the voice model for the speaker, comprise sequences of instructions that, when executed, cause the one or more machines to attempt to locate, based on the identity of the speaker, a speaker-dependent voice model for the speaker.

20. The article of manufacture of claim 19, wherein the sequences of instructions that, when executed, cause the one or more machines to retrieve from the storage area the voice model for the speaker if the voice model for the speaker is located comprise sequences of instructions that, when executed, cause the one or more machines to retrieve from an internal storage area containing speaker-dependent voice models for multiple persons the voice model for the speaker if the voice model for the speaker is located.

21. The article of manufacture of claim 19, wherein the sequences of instructions that, when executed, cause the one or more machines to retrieve from the storage area the voice model for the speaker if the voice model for the speaker is located comprise sequences of instructions that, when executed, cause the one or more machines to retrieve from an external storage area accessible over the network the voice model for the speaker.

22. The article of manufacture of claim 19, wherein the sequences of instructions that, when executed, cause the one or more machines to determine the identity of the speaker through the network over which the output data, regarding the person with access to the speech-recognition system receiving the output data, is provided to the one or more speech-recognition systems comprise sequences of instructions that, when executed, cause the one or more machines to determine the identity of the speaker through the network over which phonemes to the one or more speech-recognition systems is provided regarding the person with access to the speech-recognition system receiving phonemes.

23. The article of manufacture of claim 22, wherein the machine-accessible medium further comprises sequences of instructions that, when executed, cause the one or more machines to:
receive an utterance from the speaker;
use the voice model to extract phonemes from the utterance; and
transmit the phonemes over the network to a speech-recognition system.

24. The article of manufacture of claim 23, wherein the machine-accessible medium further comprises sequences of instructions that, when executed, cause the one or more machines to:
receive from a speech-recognition system contents of a recognized utterance of the speaker; and
revise the voice model for the speaker based on the contents of the recognized utterance.

25. The article of manufacture of claim 19, wherein the sequences of instructions that, when executed, cause the one or more machines to determine the identity of the speaker through the network over which the output data, regarding the person with access to the speech-recognition system receiving the output data, is provided to the one or more speech-recognition system s comprise sequences of instructions that, when executed, cause the one or more machines to determine the identity of the speaker through the network over which the voice model regarding the person to the one or more speech-recognition systems is provided regarding the person with access to the speech-recognition system receiving the voice model regarding the person.

26. The method of claim 19, wherein the machine-accessible medium further comprises sequences of instructions that, when executed, cause the one or more machines to transmit the voice model over the network to a speech-recognition system.

27. The article of manufacture of claim 26, wherein the machine-accessible medium further comprises sequences of instructions that, when executed, cause the one or more machines to:
retrieve a speaker-independent voice model if failing to locate the voice model for the speaker;
receive an utterance from the speaker;
use the speaker-independent voice model to extract phonemes from the utterance;
transmit the phonemes over the network to a speech-recognition system;
receive from the speech-recognition system contents of a recognized utterance of the speaker; and
generate a voice model for the speaker based on the contents of the recognized utterance.

28. An apparatus, comprising:
an identification determiner to determine an identification of a speaker through a network over which output data, regarding a person with access to a speech-recognition system receiving the output data, is provided to one or more speech-recognition systems;
a voice-model locator to locate a speaker-dependent voice model for the speaker based on the identity of the speaker; and
a voice-model retriever to retrieve the speaker-dependent voice model for the speaker from a storage area based on the identity of the speaker.

29. The apparatus of claim 28, further comprising:
an utterance receiver to receive an utterance from the speaker;
a phoneme extractor to extract phonemes from the utterance using the speaker-dependent voice model; and
a phoneme transmitter to transmit the phonemes over the network to a speech-recognition system.

30. The apparatus of claim 26, further comprising:
a recognized-utterance receiver to receive from a speech-recognition system contents of a recognized utterance of the speaker; and
a voice model reviser to revise the speaker-dependent voice model of the speaker based on the contents of the recognized utterance.
